(19) United States
(12) Patent Application Publication
(10) Pub. No.: US 2010/0196620 A1
(43) Pub. Date: Aug. 5, 2010

(54) PROCESS FOR COATING A BELT, IN PARTICULAR THE FABRIC OF A PAPER MACHINE

(76) Inventors: Robert Eberhardt, Ellwangen (DE); Jacqueline Marz, Heidenheim (DE); Matthias Schmitt, Munchen (DE)

Correspondence Address: TAYLOR & AUST, P.C., P.O. Box 560, 142. S Main Street, Avilla, IN, 46710, US

(21) Appl. No.: 12/701,009

(22) Filed: Feb. 5, 2010

(30) Foreign Application Priority Data
Feb. 5, 2009 (DE) DE102009000639.7

(51) Int. Cl. B05D 3/14; B05D 1/02; B05D 1/36; B05D 3/02

(52) U.S. Cl. 427/535; 427/421.1; 427/427.3; 427/424; 427/402; 427/372.2; 427/209

(57) ABSTRACT

The present invention relates to a method of coating a technical textile belt or fabric for a machine to produce a fibrous web of material, for example paper, cardboard, or tissue, which includes the step of i) providing a belt, whereby a coating is applied onto one side of belt; ii) providing of an applicator device, with which a liquid medium can be applied onto one side of belt without actually coming in contact with the belt; iii) applying the liquid medium onto one side of the belt; and iv) causing the liquid medium to bond and develop in order to allow the formation of a solid coating covering on the side of the belt and/or the inner structure covering at least a portion of the side of the belt. The method according to the present further provides that in invention step iii), the applicator device, follows a previously established raster in applying pre-determined quantities of the coating medium onto a plurality of locations, located within at least one region on the side of the belt. The coating medium and the material and/or the structure of the belt are further selected in such a way that the coating medium will spread out on the surface of the side of the belt and/or from the surface of the side into the interior of the structure of the belt.

### BACKGROUND OF THE INVENTION

1. Field of the Invention

The present invention relates to a method of coating a technical textile belt or a technical fabric for a machine for the production of a fibrous web, for example, paper, cardboard, or tissue.

2. Description of the Related Art

In order to improve their properties, coating media are applied in their liquid state onto technical fabrics, for example, fabrics for a paper machine, where upon subsequently these layers which cover the base material bond and harden. According to the current state of technology, these liquid coating media are often applied onto the surface of the side of the fabric that is to be coated via direct contact with an application roller.

It is furthermore known to apply liquid coating media via a spraying process onto the surfaces of technical fabrics. This process usually calls for spray nozzles which are spaced apart from one another and which send out liquid coating media onto the technical fabrics. The spray cones may, however, partially overlap so that it is not possible to control the quantity of coating medium at every location of the belt. As a result, the coatings are often distributed unevenly, leading to non-uniform coating thicknesses.

What is needed in the art is a method by which a small quantity of coating medium can be dispensed such that the coating is distributed in a manner that will result in the most even or uniform coating possible.

### SUMMARY OF THE INVENTION

The present invention provides a method of applying a coating onto a technical textile belt, in particular onto a fabric for a machine for the production of a fibrous web, for example, paper, cardboard or tissue, the method including the steps of:
i) providing a belt, whereby a coating is applied onto one side of the belt;
ii) providing an applicator device with which a liquid medium can be applied onto at least one side of the belt without actually coming in contact with the belt; iii) applying the liquid medium onto the side of the belt; and
iv) causing the liquid medium to bond and develop a solid coating covering the side of the belt and/or the inner structure underneath at least a portion of the side of the belt.

The method according to the present invention further provides that in step iii) the applicator device follows a previously established raster in applying pre-determined quantities of the liquid coating medium onto a plurality of locations located within at least one region on the side of the belt that is being coated. The coating medium and the material and/or the structure of the belt are selected in such a way that the coating medium will spread out on the surface of the side of the belt and/or from the side of the belt into the interior of the structure of the belt.

The surface of a belt, for example that of a textile screen, can correspond in a general way to the interwoven threads of warp and weft. If the belt is a multi-layered screen, then the surface of one side of the belt, for example, the side that is being coated, can be approximately determined by the total area of the openly exposed thread surfaces. The interior structure, for example, is defined by the areas of openly exposed thread surfaces that are located in the interior of the belt, which includes the thread surfaces that are neither exposed to one side of the belt, for example, the side that is to be coated and where the paper is located, nor to the opposite side of the belt, for example, the side that faces the machine. If the belt is a press felt, then the surface of the side of the belt that is to be coated can be approximately determined, for example, by the surface of a fiber fleece layer which is exposed to that side of the belt that is to be coated. The interior structure can be approximately determined by the thread surfaces of, for example, the base structure and/or the one fiber fleece layer or a plurality of fiber fleece layers which are exposed in the interior of the belt, including the threads or thread surfaces that are neither exposed to one side of the belt, such as the side that is to be coated and where the paper is located, nor exposed to the opposite side of the belt, such as the side that faces the machine. The transition from the surface of the belt herein to the interior of the belt is a flowing one.

The method according to the present invention provides that the coating medium, applied onto a plurality of locations is spread out, at least in one region, substantially evenly or uniformly so that after the coating medium has bonded and becomes solid in this region, an at least partial and a completely coherent coating is formed out of a fairly evenly distributed quantity of coating on the surface of the side to which coating is applied and/or in the interior structure within this region of the coated side of the belt. Because the coating medium and the material and/or the structure of the belt are selected in such a way that the coating medium will spread out after it has been applied onto the surface of the side and/or from that one side into the interior of the structure of the belt, an even distribution of the liquid coating material is achieved. Because of the manner in which pre-determined amounts of coating media are applied according to the present invention onto particular locations that are arranged in a raster, it is possible to coat targeted areas completely and evenly while keeping the amounts of coating medium that is being used to a minimum. It is, therefore, possible to produce substantially evenly distributed coatings on technical fabrics in spite of only using small amounts of the coating medium.

A coating that is substantially evenly distributed can, for example, be understood as follows: If the side of the belt that is to be coated were to be divided into several regions of equal size, then the amounts of coating in these different areas would not be any less than 20% less than the area with the most amount of coating, for example, 10% less than the area with the most amount of coating.

The application of the liquid coating medium can consist of a single application step or multiple application steps that follow after one another in chronological order. In each of the application steps, a pre-determined amount of liquid coating medium can be applied onto each of a plurality of locations. The amounts of coating medium that are being applied onto the plurality of locations may vary between at least two of these locations, or alternatively be the same amount in all locations.

The liquid coating medium may be applied in the form of droplets or in the form of a continuous stream. In the case of the application of a continuous stream, the locations are in the form of lines, which are in particular detached or isolated from one another. Furthermore, in the case of the application of droplets, the locations are in the form of round objects, which are detached or isolated from one another. In the case of a continuous application, the application step extends over a longer period of time than if droplets are applied. In the latter case, the application would only extend long enough to apply a single drop onto the side of the belt.

The spray nozzles, which are employed for known spraying processes, produce streams of coating that tend to fan out, which causes large variations of the amount of coating medium across the width of the technical fabric. It is furthermore very difficult to aim such small quantities of coating medium accurately because the spray nozzles tend to drip between application steps. It is because of this that such spray nozzles are less well suited for the application of droplets.

Therefore, an embodiment of the method of the present invention provides that the applicator device, with which the coating medium is applied onto the belt, includes at least one spray nozzle that operates according to the piezo-printer concept and/or at least one spray nozzle that operates according to the pressure-valve-printer concept and/or at least one spray nozzle that operates according to the bubble-jet-printer concept.

According to the bubble-jetprinter concept, tiny droplets of the coating medium are created with the help of a heating element which heats the coating medium above its boiling point. This causes a tiny steam bubble, which in an explosion-like event pushes with the pressure that it exerts a droplet of the liquid coating medium out of the spray nozzle.

The piezo printer employs a ceramic element. This element deforms during brief electric voltages, which in turn leads to the liquid coating medium being pushed through the application nozzle. The use of the electric impulses provides a way to control the size of the droplets which are being created.

In a pressure-valve printer, individual nozzles are placed at the applicator nozzles, which can be controlled to open and close. If a drop of the coating medium is supposed to leave the applicator nozzle, the valve is opened. In pressure-valve printers, the liquid coating medium is under a continuously exerted pressure.

With the aforementioned printer concepts, it is possible to apply pre-determined amounts of a liquid coating medium onto one side of a belt. Since, with these printer concepts, only a very small amount of coating medium is dispensed with each print impulse, i.e. during each application step, very small quantities of coatings can be locally targeted onto technical fabrics. This is contrary to the application of coating media with known spraying processes, in which spray nozzles are employed with which no pre-determined small amounts of coating medium can be applied since they tend to drip after each completed application step.

By employing the aforementioned printer concepts, it is furthermore possible to cover the side of the belt uniformly with very small amounts of liquid coating medium, since the piezo printer, the pressure-valve printer or the bubble-jet-printer usually consist of arrays of at least two, but often more, application nozzles, whose spacing to one another is very close relative to the dimensions of the fabric of a paper machine so that local variations in the applied amounts of coating are very small relative to the dimensions of the fabric of the paper machine and are, therefore, negligible.

In particular, the use of a pressure-valve printer allows the liquid coating medium to be applied either as a continuous stream or in the form of droplets, since this particular concept requires that the coating medium be under steady pressure inside the application nozzle, and since the pressurized coating medium will leave the application nozzle as long as the valve which controls the flow at the application nozzles remains open. This means that controlling the opening duration of the valve will determine the amount of coating medium that is dispensed, and it will determine whether the coating medium will leave the application nozzle in the form of individual droplets or in the form of a stream.

A second embodiment of the present invention provides that the application device includes a plurality of application nozzles that can be controlled independently of one another, and which function according to one of the aforementioned concepts. All of the application nozzles that are part of the application device may, for example, function according to the same concept. It is furthermore provided that all of the application nozzles may be placed in a common nozzle head.

Further, the belt and at least one of the application nozzles or the nozzle head which contains a plurality of the application nozzles may move with respect to one another during an application step and/or move with respect to one another between two immediately successive application steps. This allows for the application of a coating across extensive areas of the side of the fabric.

The term application step herein refers to the duration of time, during which the liquid coating medium is dispensed from at least one application nozzle, or from the application nozzles, respectively. Accordingly, the belt and the application nozzle(s) may not move with respect to one another during the application step, but may only move with respect to one another between two successive application steps. Furthermore, the belt and the application nozzle(s) may only move with respect to one another during the application step, and may not move with respect to one another between two successive application steps. Alternatively, the belt and the application nozzle(s) may move with respect to one another during the application step as well as between two successive application steps.

The movement between the belt and the at least one application nozzle, or the nozzle head, respectively, can be facilitated by movement of the belt in its longitudinal direction, for example around two parallel rolls spaced apart from one another, and/or by letting at least one application nozzle or the nozzle head, respectively, traverse in a direction orthogonal to the longitudinal direction of the belt. The movement of the belt and/or the movement of the at least one application nozzle, or the nozzle head, respectively, may, for example, be controlled by a software program in order to facilitate the application of the coating in a pattern onto the surface of the side of the belt. Additionally, several applicator nozzles may be controllable independent of one another by the same software program.

The quantities of liquid coating medium applied onto each square meter of the side of the belt is adjustable by such means as, for example, the control of the relative velocity of the application device and the belt and/or the pressure applied to the liquid coating medium inside the application nozzle and/or the viscosity of the liquid coating medium and/or the duration of the application step and/or the frequency of successive application steps and/or the diameter of the orifice of at least one application nozzle and/or the distance between the orifice of the application nozzle and the surface of the side of the belt that is to be coated.

Further, the surface energy of the surface of the side of the belt that is to be coated may be adjusted to the surface energy of the liquid coating medium such that the liquid coating medium will substantially wet the surface of the side of the belt. If the coating medium is, for example, an aqueous solution, then the surface of the side of the belt that is to be coated may be hydrophilic.

The structure of the belt itself can also affect the spreading of the liquid coating medium on the side of the belt. Worth mentioning are capillary effects, which determine how the liquid coating medium spreads on the surface of the one side and how it enters through crevices and cavities inside into the interior structure of the belt.

A further influencing factor is the viscosity of the coating medium. In order to obtain the most even spreading of the coating medium possible across the surface of the side that is being coated and/or from the surface of the side that is being coated into the interior structure of the belt, the method according to the present invention provides that the viscosity of the coating medium is less than 500 mPa·sec, for example less than 300 mPa·sec, or less than 150 mPa·sec.

An additional embodiment of the method of the present invention provides that the nearest neighboring locations on the surface of the side of the belt to be coated where at least one coating medium is applied are no more than 20 mm apart from one another, for example, no more than 5 mm apart from one another, or no more than 2 mm apart from one another. In this instance, the coating medium may be applied with 25 droplets per inch (dpi).

In this context, the distances between the locations where coating medium is applied on the surface of side of the belt can be established by the distance between neighboring applicator nozzles inside of the nozzle head and/or through the movement of the applicator nozzles relative to the surface of the side of the belt that is to be coated. Because the distances between the nearest neighboring location onto which coating medium is applied are very small relative to the dimensions of the technical fabric, the latter usually being in the range of approximately 10 m in width or more, the raster of points onto which coating is applied on the side of the belt is a very tight one, so the variations between amounts of liquid coating medium applied to the plurality of points per unit area may be leveled out.

The liquid coating medium may be further adjusted to the belt as well as to the distance between the nearest neighboring points on the surface of the side of the belt onto which the liquid coating medium is being applied, such that the liquid coating medium will spread out evenly and, thus, produce a distribution that is substantially uniform.

Since, by employing the piezo-printer concept and/or the pressure-valve printer concept and/or the bubble-jetprinter concept, it is possible to apply very small amounts of coating medium, which in turn produces very evenly distributed coatings, the relative amount of coating medium that are being applied are actually very small.

According to the method of the present invention, the distance between the orifice of the at least one application nozzle, and the surface of the one side of the belt that is to be coated, may be within a range of between approximately 0 mm and 50 mm, for example, within the range of between approximately 0.2 mm and 20 mm, or within the range of between approximately 0.5 mm and 5 mm. Because the distance between the surface of the belt and the application nozzle is so small, it is advantageously possible to place the coating medium with great precision on the intended locations on the surface of the one side of the belt.

In order to dispense a small amount of liquid coating medium in each application step, the method according to the present invention further provides that the diameter of the orifice of the application nozzle is within the range of between approximately 0.05 mm and 2.5 mm, for example, within the range of between approximately 0.15 mm and 0.6 mm.

In order to obtain a sufficiently even distribution of the coating on the surface of the side of the belt, the quantity of the liquid coating medium that is being dispensed onto each square meter of the surface of the side of the belt may, for example, be within the range of between approximately of 20 ml and 3,000 ml.

The outcome may vary depending on whether the liquid medium is applied onto a belt of felt or screen, because the liquid coating medium will tend to spread into the interior structure of a felt, while a coating applied to the surface of a screen will spread out but remain on the surface of the screen. The amount of coating medium that is applied onto a square meter of a belt that is made out of a felt may be within the range of between approximately 200 ml and 2,000 ml per square meter of felt, for example, within the range of between approximately 400 ml and 1,200 ml per square meter of felt. The amount of coating medium that is applied onto a square meter of a belt made out of a screen, for example, a woven fabric or a spiral screen, may be within the range of between approximately 20 ml and 500 ml per square meter of screen, for example, within the range of between approximately 40 ml and 250 ml per square meter of screen.

The at least one application nozzle may dispense in successive order, meaning in several application steps following one another, the pre-defined amounts of coating medium that are appropriate for each of the respective application steps. The coating medium may be applied by the application nozzle onto different locations on the surface of the side of the belt to which the coating is being applied or the coating medium may be applied by the at least one application nozzle a plurality of times onto the same location on the surface of the side of the belt to which the coating is being applied.

The amount of coating medium that is applied during each application step may be within the range of between approximately 1 nl (Nanoliter) to 200 μl (Microliter), for example, within the range of between approximately 20 nl (Nanoliter) up to 100 μl (Microliter).

The method of the present invention further provides that a plurality of different liquid coating media may be applied at the same location at least somewhere on the surface of the side of the belt to which the coating is being applied. In this context, these different liquid coating media, applied at the same location at least somewhere on the surface of the side of the belt, may chemically react with one another.

It is furthermore provided that the plurality of different liquid coating media applied at the same location on the surface of the side of the belt, may have different mechanical and/or chemical properties from one another, and they may not chemically react with one another. At least one of these coating media, may either be chemically and/or thermally activated in order to develop the coating.

The method may be carried out in such a way that the liquid, which is applied onto the surface of the side of the belt, spreads onto the surface of the side of the belt that is opposite to the one where it was originally applied, and/or that this liquid will spread into the interior structure of the belt and all the way across to the surface of the side of the belt that is opposite to the one where it was originally applied. This approach may, for example, by applying the coating medium onto the surface of only one side of the belt, create a coating that covers the entire surface of the belt, meaning the surface of the side of the belt where the liquid coating medium was originally applied, as well as the side of the belt that is opposite to the one where the liquid coating medium was applied, and/or the interior structure that is in-between the two opposing surfaces, extending from one side to the opposite side.

The side of the belt to which the coating is applied may touch the fibrous web that is to be produced with the machine, while the opposite side of the belt is the one that is in contact with the machine itself. The contrary is, however, just as conceivable, meaning that the side of the belt that is being applied with the liquid coating medium is the one that is in contact with the machine, while the opposite side of the belt is in contact with the fibrous web.

With the aforementioned printer types, the frequency with which droplets of the liquid coating medium are dispensed and/or the size of the droplets of the liquid coating medium that are being dispensed may be adjusted. If, for example, the at least one application nozzle, functions according to the pressure-valve-printer concept, then the quantity of the liquid coating medium that is to be applied may be adjusted, for example, by varying the duration for which the orifice of the application nozzle is open and/or by varying the frequency at which the orifice of the application nozzle is opened to dispense the liquid coating medium.

Depending on the requirements of the belt, the at least one liquid coating medium, may be applied onto just one particular region of the belt. The at least one liquid coating medium may, alternatively be applied onto a plurality of different regions of the belt. The regions can be, depending on the requirements of the belt, adjacent to one another partially overlap one another, or be spaced apart from one another or be somehow detached from one another.

The at least one liquid coating medium, may be applied to the entire side of the belt, in order to create a coating that covers at least the side of that belt onto which the liquid coating medium is applied in its entirety.

In order to improve the adhesion or tenacity of the coating onto the surface of the one side of the belt and/or to enhance the spreading of the liquid coating medium on the surface of the one side of the belt, the side of the belt which is to be coated may be mechanically and/or chemically pre-treated, or for example, activated, before the liquid coating medium is applied onto that side of the belt. This activation of the surface may be achieved by use of a plasma treatment, for example, by use of a plasma treatment under atmospheric pressure. The surface material of the belt may also be polarized through the plasma treatment in the region of side of belt which is to be coated. This sort of polarization can, for example, in particular improve the way that an aqueous coating medium will spread across the surface of that side of the belt. In addition, this sort of treatment will also cleanse the surface of the side of the belt that is to be coated, for example, by removing existing finishes or organic hydrophobic pollutants.

The at least one liquid coating medium, may contain, for example, a solution, a dispersion or a suspension or it might itself be one of these substances. The liquid coating medium may further contain oligomers, polymers and or polymeric building components. The liquid coating medium may furthermore contain antifoams, wetting agents, emulsifiers, catalysts, cross-linking reagents or buffer systems. The liquid coating medium may be a reactive substance, for example, a moisture cross-linking polymeric resin. In order to employ such a reactive substance, the storage tank for this type of liquid coating medium must be inaccessible to the respective reaction partner, for example air humidity. At least one of the liquid coating media may further be a pure substance.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a top view of a belt in the shape of a screen before it has been coated according to the method of the present invention;

FIG. 2 is the screen shown in FIG. 1, after it has been coated with the liquid coating medium according to the method of the present invention; and

FIG. 3 is the screen shown in FIGS. 1 and 2, after liquid coating medium has been spread out on the depicted surface according to the method of the present invention.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

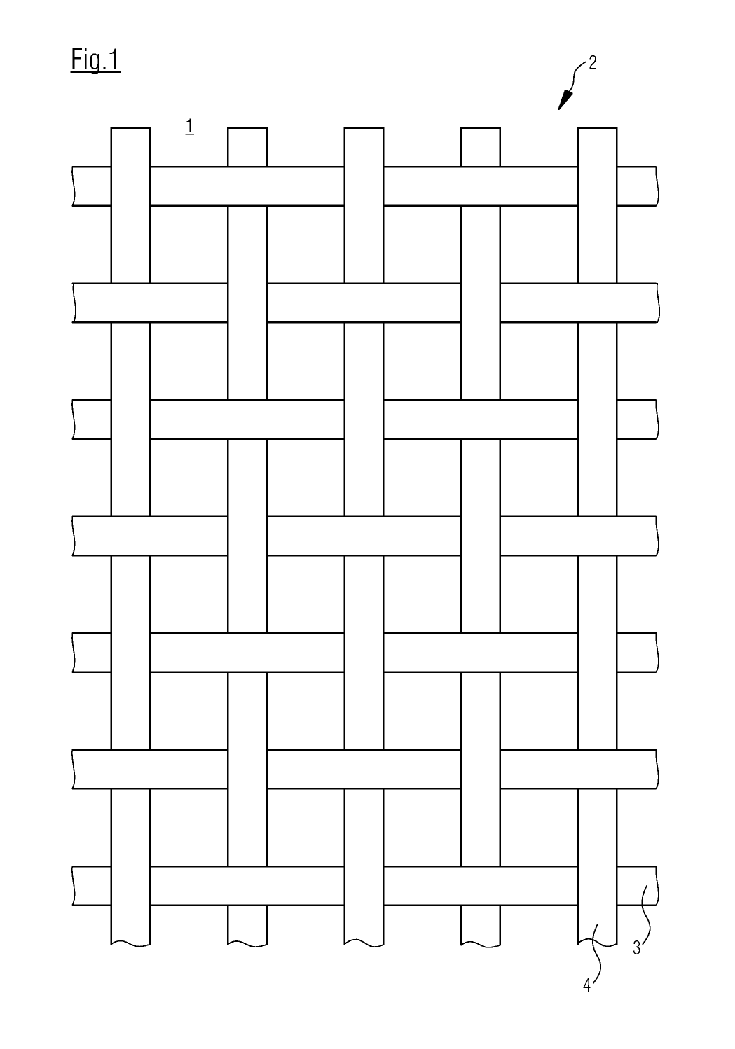

Referring now to the drawings, and more particularly to FIG. 1, there is shown a top view of side 1 of a belt that is to be coated, which is in the form of screen 2 before it has been applied with a coating. Screen 2 is a textile product, which is formed out of warp and weft threads 3 and 4.

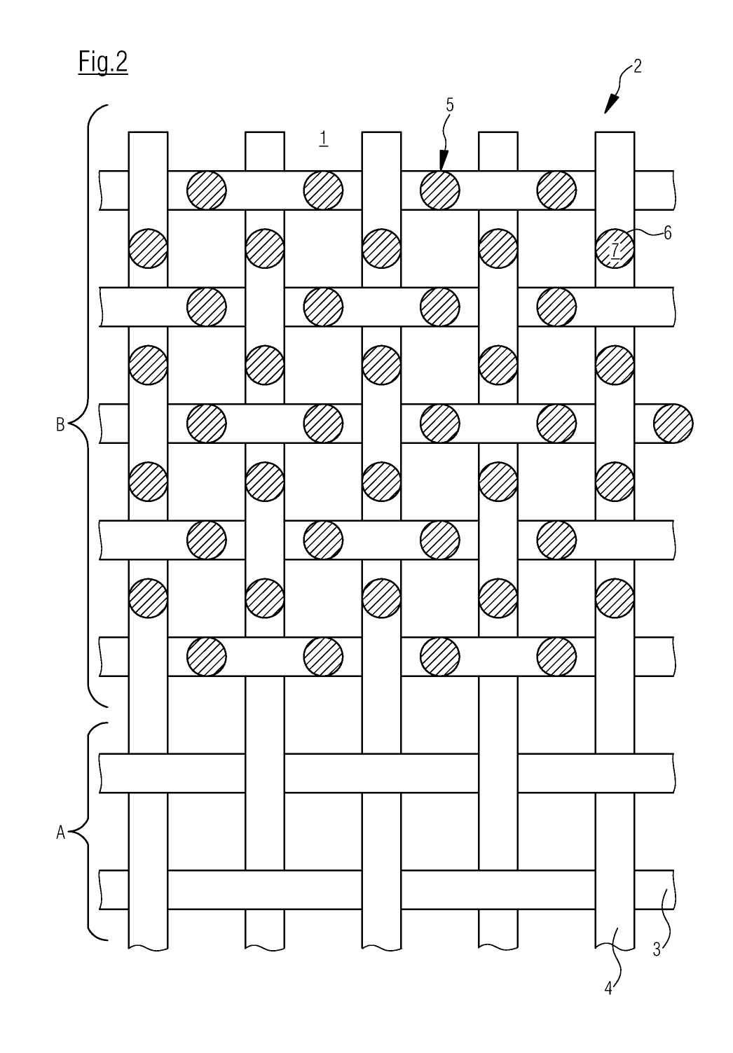

Referring now to FIG. 2, there is shown screen 2 shown in FIG. 1 immediately after the application of liquid coating medium 5. Liquid coating medium 5, in this case has only applied to portion B on the side of screen 2, so that portion A of screen 2 has not been covered with the coating.

According to the method of the present invention, a pre-defined quantity of liquid coating medium 5 has been applied by the applicator device according to a previously established raster onto a plurality of locations 6 within region B on side 1 of screen 2, without allowing the applicator device to come into direct contact with screen 2. In the depicted example, individual droplets 7 of coating medium 5 have been applied onto side 2, whereby plurality of locations 6 individual droplets 7 on side 1 of belt 2 are spatially separated from one another as they are being applied onto belt 2.

In this depicted example, coating medium 5, is an aqueous polymer dispersion with a solid content of in a range of between approximately 5-30 weight %, for example, in a range of between approximately 5-10 weight %, and having a viscosity in the range of between approximately 10-70 mPa·sec, for example, in a range of between approximately 15-20 mPa·sec.

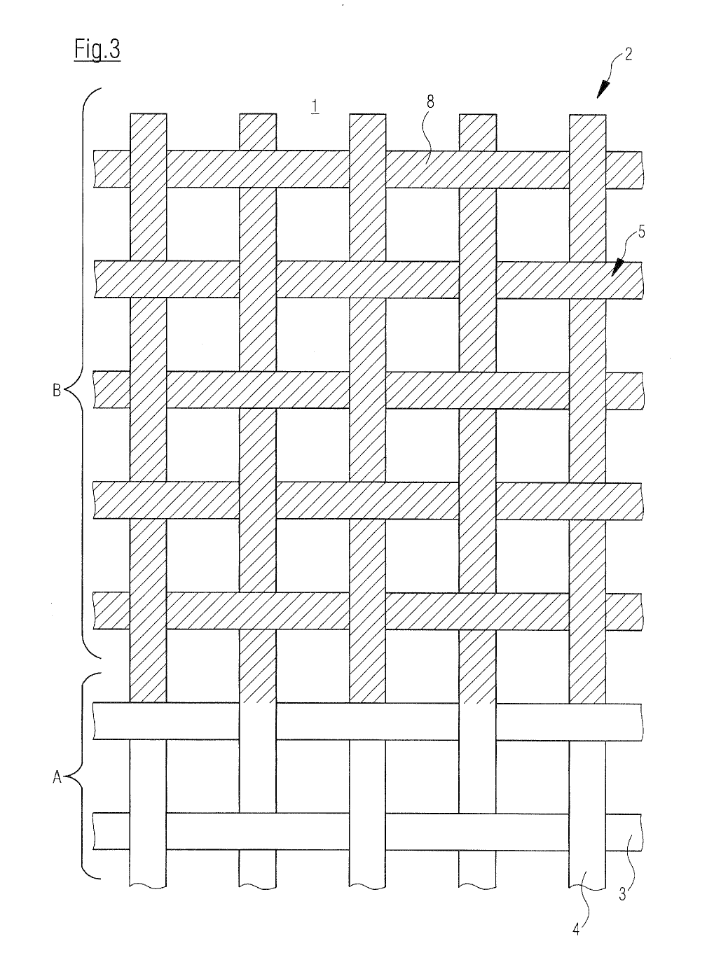

Furthermore, coating medium 5 and the material and structure of belt 2 are selected in such a way that coating medium 5 will spread out on the surface of side 1 and, thus be substantially evenly distributed in region B, so that once the coating medium is bonded and has become solid, coating film 8 has formed of uniform thickness, as depicted in FIG. 3.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for coating a technical textile belt, comprising the steps of:
i) providing a belt;
ii) providing an applicator device configured to apply a liquid coating medium onto one side of the belt without actually contacting said belt;
iii) applying said liquid medium onto one side of said belt, wherein said applicator is configured to follow a predetermined raster in applying a predetermined quantity of said liquid coating medium onto a plurality of predetermined locations within at least one region on said one side of said belt, said liquid coating medium and at least one of a material and a structure of said belt are selected such that said liquid coating material spreads out at least one of on a surface of at least one of said side of said belt and from said side of said belt into an interior structure of said belt; and
iv) causing said liquid medium to bond to form a solid coating covering at least a portion of one of said one side of said belt and said interior structure of said belt.

2. The method according to claim 1, wherein said predetermined locations are formed as lines, said lines being detached from one another.

3. The method according to claim 1, wherein said predetermined locations are formed as round objects, said round objects being detached from one another.

4. The method according to claim 3, wherein said applicator device configured to apply said liquid coating medium includes at least one spray nozzle functioning according to at least one of the piezo-printer concept, the pressure-valveprinter concept and the bubble-jetprinter concept.

5. The method according to claim 4, wherein said application device includes a plurality of application nozzles included in a nozzle head, said plurality of application nozzles configured to be controlled independently of one another.

6. The method according to claim 5, wherein at least one of said belt, said at least one application nozzle, and said nozzle head including said plurality of application nozzles move with respect to one another at least one of during of said application step and between two immediately successive application steps.

7. The method according to claim 6, wherein said movement is facilitated by movement of at least one of said belt in a longitudinal direction, said at least one application nozzle and said nozzle head, wherein said at least one application nozzle and said nozzle head traverse a direction orthoganol to said longitudinal direction of said belt.

8. The method according to claim 7, wherein said movement of said at least one of said belt, said at least one application nozzle and said nozzle head is controlled by a software program to facilitate said application of said liquid coating medium in a pattern onto said one side of said belt.

9. The method according to claim 8, wherein a viscosity of said liquid coating medium is less than approximately 500 mPa·sec.

10. The method according to claim 9, wherein said viscosity of said liquid coating medium is less than approximately 300 mPa·sec.

11. The method according to claim 9, wherein said viscosity of said liquid coating medium is less than approximately 150 mPa·sec.

12. The method according to claim 11, wherein each of said plurality of detached locations to which said at least one liquid coating medium is applied has a plurality of neighboring locations, a location of said plurality of detached locations being less than 20 mm apart from a nearest location of said plurality of neighboring locations.

13. The method according to claim 12, wherein a distance between an orifice of said at least one application nozzle and a surface of said one side of said belt is within a range of between approximately 0 mm and 50 mm.

14. The method according to claim 13, wherein said distance between said orifice of sat at least one application nozzle and said surface of said one side of said belt is within a range of between approximately 0.2 mm and 20 mm.

15. The method according to claim 14, wherein said distance between said orifice of sat at least one application nozzle and said surface of said one side of said belt is within a range of between approximately 0.5 mm and 5 mm.

16. The method according to claim 15, wherein a diameter of said orifice of said application nozzle is within a range of between approximately 0.05 mm and 2.5 mm.

17. The method according to claim 16, wherein said diameter of said orifice of said application nozzle is within a range of between approximately 0.15 mm and 0.6 mm.

18. The method according to claim 17, wherein said at least one application nozzle dispenses in a plurality of successive application steps, each of said plurality of successive application steps applying a predetermined volume of said liquid coating medium.

19. The method according to claim 18, wherein said predetermined volume of said liquid coating medium applied in each of said plurality of successive application steps is within a range of between approximately 2 nl to 200 μl.

20. The method according to claim 19, wherein a plurality of different coating media are applied to one location of said plurality of locations on said side of said belt.

21. The method according to claim 20, wherein said plurality of different liquid coating media applied to said one location of said plurality of locations on said side of said belt are chemically reacted with another of said plurality of liquid coating media to develop said coating.

22. The method according to claim 21, wherein at least one liquid medium of said plurality of different liquid coating media has at least one of a different mechanical property and a different chemical property from another of said plurality of liquid coating media.

23. The method according to claim 22, wherein said at least one liquid medium of said plurality of liquid media is at least one of chemically activated and thermally activated to develop said coating.

24. The method according to claim 23, wherein said liquid coating medium applied onto said surface of said one side of said belt spreads one of on a second surface of a second side of said belt opposite said one side of said belt to which said liquid coating medium is applied and into an interior structure of said belt to said second surface.

25. The method according to claim 24, wherein said volume of said liquid coating medium is adjusted by at least one of control of a relative velocity of said application device and said belt, a pressure applied to said liquid coating medium in side said application nozzle, said viscosity of said liquid coating medium, a duration of said application step, a frequency of said successive application steps, said diameter of said orifice of at least one application nozzle and a distance between said orifice of said application nozzle and said surface of said one side of said belt.

26. The method according to claim 25, wherein a volume of between approximately 20 mL and 3,000 mL of said liquid coating medium is applied onto each square meter of said surface of said one side of said belt being coated.

27. The method according to claim 26, wherein said surface of said one side of said belt being coated is pretreated before said application of said liquid coating medium.

28. The method according to claim 27, wherein said surface of said one side of said belt being coated is activated before said application of said liquid coating medium.

29. The method according to claim 28, wherein said activation is by use plasma treatment.

30. The method according to claim 29, wherein said plasma treatment is a plasma treatment under atmospheric pressure.

31. The method according to claim 30, wherein said technical textile belt is a fabric for a machine for the production of a fibrous web.
